(19) United States
(12) Patent Application Publication
(10) Pub. No.: US 2007/0094001 A1
(43) Pub. Date: Apr. 26, 2007

(54) Method and system for non-intrusive code coverage

(75) Inventor: Li Shaofan, Shanghai (CN)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: INTEL CORPORATION, Santa Clara, CA (US)

(21) Appl. No.: 10/560,257

(22) PCT Filed: Jun. 28, 2005
(86) PCT No.: PCT/CN05/00938

§ 371 Date: Dec. 9, 2005

(51) Int. Cl. G06F 9/45

(52) U.S. Cl. 703/22

(57) ABSTRACT

A method and system for non-intrusive code coverage is described. The method includes configuring a CPU to notify an information collection module when a branch is taken, recording a branch address when the information collection module is notified of a branch taken, and storing the recorded branch addresses to determine code coverage of a target program.

### TECHNICAL FIELD

Embodiments of the invention relate to software testing, and more specifically to non-intrusive code coverage.

### BACKGROUND

Code coverage tools are used to collect information about software testing to determine whether a software program has been tested thoroughly. Typically, code coverage tools instrument code into a target program in order to collect code coverage information. The code coverage code is either instrumented into the target program source code or into the target executable directly. This instrumentation is intrusive to the target program and increases the size of the target program.

### BRIEF DESCRIPTION OF THE DRAWINGS

The invention is illustrated by way of example, and not by way of limitation, in the figures of the accompanying drawings in which like reference numerals refer to similar elements.

FIG. 1 is a block diagram illustrating a suitable computing environment in which certain aspects of the illustrated invention may be practiced.

FIG. 2 is a block diagram illustrating one generalized embodiment of a system incorporating the invention.

FIG. 3 is a flow diagram illustrating a method according to an embodiment of the invention.

### DETAILED DESCRIPTION

Embodiments of a system and method for non-intrusive code coverage are described. In the following description, numerous specific details are set forth. However, it is understood that embodiments of the invention may be practiced without these specific details. In other instances, well-known circuits, structures and techniques have not been shown in detail in order not to obscure the understanding of this description.

Reference throughout this specification to “one embodiment” or “an embodiment” means that a particular feature, structure, or characteristic described in connection with the embodiment is included in at least one embodiment of the invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

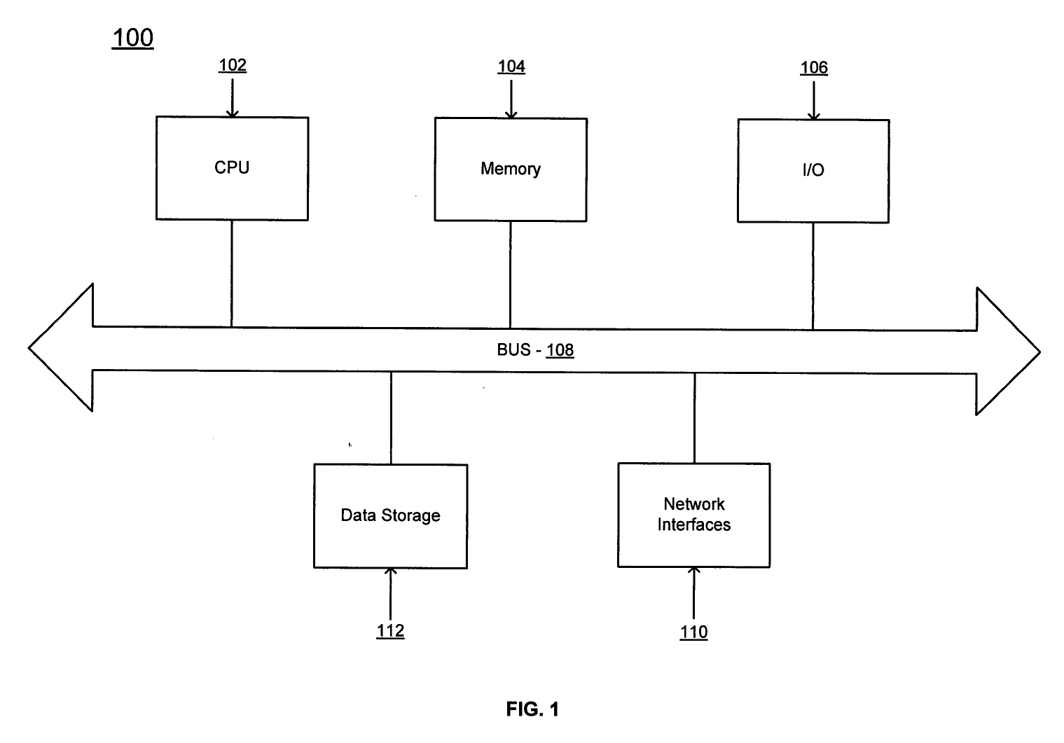

FIG. 1 is a block diagram illustrating a suitable computing environment in which certain aspects of the illustrated invention may be practiced. Methods of the invention may be implemented on a computer system 100 having components 102-112, including a central processing unit (CPU) 102, a memory 106, an Input/Output device 104, a data storage device 112, and a network interface 110, coupled to each other via a bus 108. The components perform their conventional functions known in the art and provide the means for implementing the system 100. Collectively, these components represent a broad category of hardware systems, including but not limited to general purpose computer systems, mobile or wireless computing systems, and specialized packet forwarding devices. It is to be appreciated that various components of computer system 100 may be rearranged, and that certain implementations of the present invention may not require nor include all of the above components. Furthermore, additional components may be included in system 100, such as additional processors, storage devices, memories (e.g. RAM, ROM, or flash memory), and network or communication interfaces.

As will be appreciated by those skilled in the art, the content for implementing an embodiment of the method of the invention, for example, computer program instructions, may be provided by any machine-readable media which can store data that is accessible by system 100, as part of or in addition to memory, including but not limited to cartridges, magnetic cassettes, flash memory cards, digital video disks, random access memories (RAMs), read-only memories (ROMs), and the like. In this regard, the system 100 is equipped to communicate with such machine-readable media in a manner well-known in the art.

It will be further appreciated by those skilled in the art that the content for implementing an embodiment of the method of the invention may be provided to the system 100 from any external device capable of storing the content and communicating the content to the system 100. For example, in one embodiment of the invention, the system 100 may be connected to a network, and the content may be stored on any device in the network.

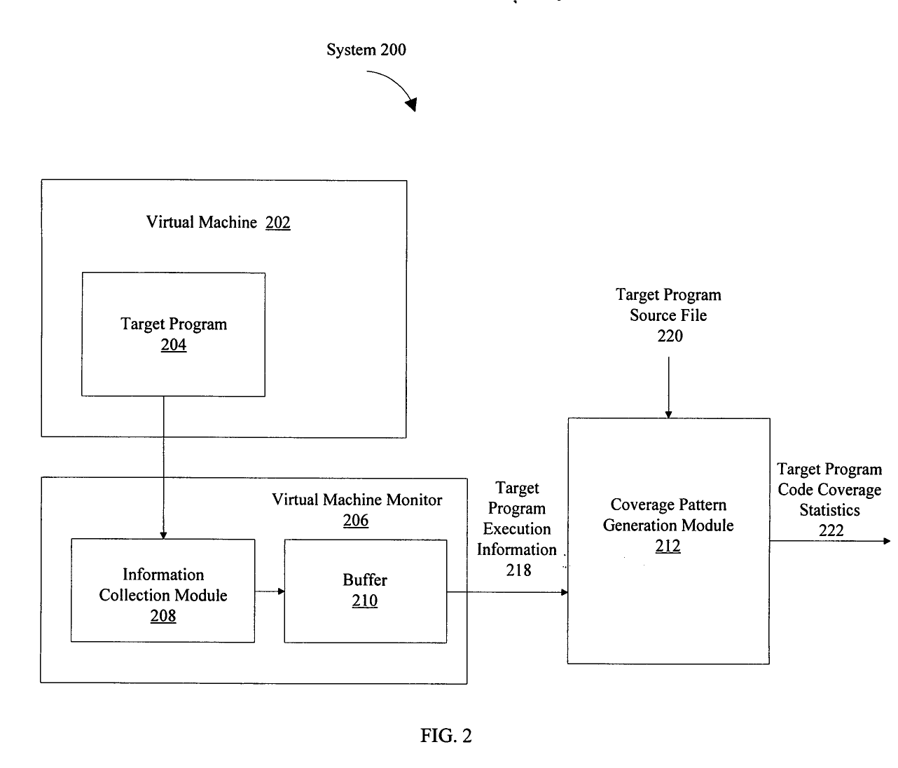

FIG. 2 illustrates a system incorporating an embodiment of the invention. System 200 includes a virtual machine (VM) 202. The virtual machine 202 may be any platform or operating system (OS) and provides a virtualization environment to run target programs, such as 204. System 200 also includes a virtual machine monitor (VMM) 206. The virtual machine monitor 206 maintains information about the virtual machine 202 and monitors programs running on the virtual machine. The virtual machine monitor 206 includes an information collection module (ICM) 208 and a buffer 210. The information collection module 208 configures the CPU 102 to notify the information collection module 208 when a branch is taken. In one embodiment, a configuration register is set to provide a notification to the information collection module 208 when a branch is taken. In one embodiment, the CPU 102 notifies the information collection module via an interruption. When the information collection module 208 is notified by the CPU 102 about the branch, the information collection module 208 records the branch address and stores the information in the buffer 210. After runtime, the execution information 218 collected and stored in the buffer 210 may be input into a coverage pattern generation module (CPGM) 212 along with the target program source file or symbol file 220. The CPGM 212 may be any graphical user interface (GUI) that converts the target program source file 220 and the execution information 218 into code coverage statistics that may be displayed to a user.

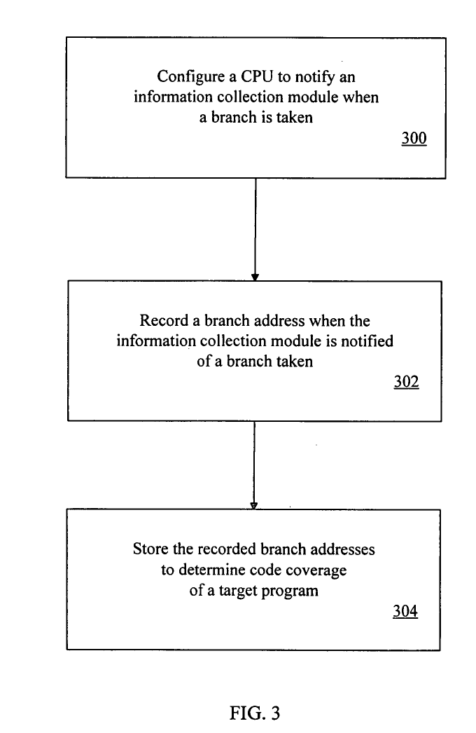

FIG. 3 illustrates a method according to one embodiment of the invention. At 300, a CPU is configured to notify an information collection module when a branch is taken. At 302, a branch address is recorded when the information collection module is notified of a branch taken. At 304, the recorded branch addresses are stored to determine code coverage of a target program on the CPU. In one embodiment, the recorded branch addresses are stored in a buffer. Then, after runtime, the recorded branch addresses may be sent to a CPGM along with the target program source file to display code coverage statistics. By recording and analyzing the branches taken, the source code of the target program that was executed may be determined. This information may then aid in determining whether software testing was adequate in covering the code of the target program.

While the invention has been described in terms of several embodiments, those of ordinary skill in the art will recognize that the invention is not limited to the embodiments described, but can be practiced with modification and alteration within the spirit and scope of the appended claims. The description is thus to be regarded as illustrative instead of limiting.

What is claimed is:

1. A method comprising:
configuring a central processing unit (CPU) to notify an information collection module (ICM) when a branch is taken;
recording a branch address when the ICM is notified of a branch taken; and
storing the recorded branch addresses to determine code coverage of a target program.

2. The method of claim 1, wherein storing the recorded branch addresses comprises storing the recorded branch addresses in a buffer.

3. The method of claim 1, further comprising providing the recorded branch addresses to a coverage pattern generation module (CPGM) to interpret and display code coverage statistics.

4. The method of claim 1, wherein the target program is to be run in a virtual machine.

5. The method of claim 4, wherein the information collection module is part of a virtual machine monitor that is coupled to the virtual machine to collect code coverage information about the target program.

6. The method of claim 1, wherein configuring a CPU to notify an information collection module when a branch is taken comprises configuring a CPU to notify an information collection module via an interruption when a branch is taken.

7. An apparatus comprising:
a virtual machine (VM) on which a target program is to execute; and
a virtual machine monitor (VMM) coupled to the virtual machine to gather code coverage information about the target program, the VMM including an information collection module (ICM) to configure a central processing unit (CPU) to notify the ICM when a branch is taken and to record a branch address when a branch is taken.

8. The apparatus of claim 7, wherein the VMM further comprises a buffer to store the branch address recorded by the information collection module.

9. The apparatus of claim 7, wherein the CPU notifies the information collection module of a branch taken via an interruption.

10. The apparatus of claim 7, further comprising a coverage pattern generation module (CPGM) coupled to the VMM to interpret the branch addresses and a source file of the target program and to display code coverage statistics about the target program.

11. An article of manufacture comprising:
a machine accessible medium including content that when accessed by a machine causes the machine to perform operations comprising:
configuring a central processing unit (CPU) to notify an information collection module (ICM) when a branch is taken;
recording a branch address when the information collection module is notified of a branch taken; and
storing the recorded branch addresses to determine code coverage of a target program.

12. The article of manufacture of claim 11, wherein the machine-accessible medium further includes content that causes the machine to perform operations comprising providing the recorded branch addresses to a coverage pattern generation module (CPGM) to interpret and display code coverage statistics.

13. The article of manufacture of claim 11, wherein storing the recorded branch addresses comprises storing the recorded branch addresses in a buffer.

14. The article of manufacture of claim 11, wherein the machine-accessible medium further includes content that causes the machine to perform operations comprising running the target program in a virtual machine.

15. The article of manufacture of claim 14, wherein the information collection module is part of a virtual machine monitor that is coupled to the virtual machine to collect code coverage information about the target program.

16. The article of manufacture of claim 11, wherein configuring a CPU to notify an information collection module when a branch is taken comprises configuring a CPU to notify an information collection module via an interruption wherever a branch is taken.

17. A system comprising:
a processor;
a network interface coupled to the processor; and
a machine accessible medium including content that when accessed by a machine causes the machine to perform operations including:
configuring a central processing unit (CPU) to notify an information collection module (ICM) when a branch is taken;
recording a branch address when the information collection module is notified of a branch taken; and
storing the recorded branch addresses to determine code coverage of a target program.

18. The system of claim 17, wherein the machine-accessible medium further includes content that causes the machine to perform operations comprising providing the recorded branch addresses to a coverage pattern generation module (CPGM) to interpret and display code coverage statistics.

19. The system of claim 17, wherein the target program is to be run on a virtual machine.

20. The system of claim 17, wherein the information collection module is part of a virtual machine monitor that is coupled to the virtual machine to collect code coverage information about the target program.
